(19) United States
(12) Patent Application Publication
(10) Pub. No.: US 2015/0032462 A1
(43) Pub. Date: Jan. 29, 2015

(54) Computer-Based Method and System for Targeted Recruiting of Healthcare Professionals

(71) Applicant: Fusion Marketing Group, Inc., Boynton Beach, FL (US)

(72) Inventors: Georgia Dardick, Boynton Beach, FL (US); Marianne Santilli, St. Petersburg, FL (US)

(73) Assignee: Fusion Marketing Group, Inc., Boynton Beach, FL (US)

(21) Appl. No.: 13/949,297

(22) Filed: Jul. 24, 2013

(51) Int. Cl. G06Q 50/22; G06Q 10/10

(52) U.S. Cl. CPC G06Q 50/22; G06Q 10/1053
USPC 705/2

(57) ABSTRACT

The computer-based recruiting method and system has a server posting a cookie on the healthcare-worker's internet-enabled-device to track the device and browser history. A semi-custom internet ad is displayed to the worker when the device is detected in an ad network. An ad hyperlink points a healthcare professional webpage. By accepting further worker input-data the computer associates the earlier logged data with the input-data which enables tracking and a cost-based analysis of the sponsored ads, the ad network, the number of internet-acts by the worker, and the geographic data. An ad generator, with a processor, creates a custom ad unique to either the worker or professional field or geographic worker-inquiry. At the web-server-portal, an input module accepts input-data A matching module associates browser history, a worker-internet-id, and the input-data.

The present invention relates to a computerized method and a computerized system for targeting healthcare professionals and recruiting those professionals for healthcare providers and healthcare facilities.

### BACKGROUND OF THE INVENTION

The widespread use of different types of computers, smart phones and computer-based tablets permits potential employees to easily search for jobs. Decades ago, a person interested in searching for a new job would read the want ads in the newspapers and then call the prospective employer or recruiting agency. With the widespread use of internet-enabled communications devices, a person seeking a job can visit, via his or her internet-enabled device, a web page or website hyperlinked to a sponsored ad paid for by the healthcare facility or healthcare provider. With respect to large facilities or providers, these institutions typically have online recruitment web portal and specialized web pages enabling the collection of data from recruits. This recruitment data and web portal is generally are separate from the human resources (HR) databases for current employees and independent contractors used by the healthcare facility or healthcare provider.

There is a need to better tract prospective employees or recruits who may be interested in changing jobs or finding a new job locally or throughout the nation. Further, there is a need for a system which tracts internet-enabled devices used by potential recruits and to tie that information to the where and how and when the recruit is engaged directly or indirectly by the healthcare facility or healthcare provider. Additionally there is a need for a recruitment system which actively seeks out and provides customized or semi-customized information for a potential employee or recruit.

### OBJECTS OF THE INVENTION

It is an object of the present invention to provide a computer based method for recruiting a healthcare professional who uses an internet enabled device such as a desktop computer, a laptop computer, a smartphone, a computer tablet or any other internet enabled device that enables communications over the internet or telecommunications system to one or more websites.

It is another object of the present invention to track a potential recruit using a cookie installed on the recruit's internet-enabled device.

It is a further object of the present invention to provide semi-custom ads which promote a particular healthcare facility or healthcare provider thereby increasing the probability that the potential recruit will apply for an employment position with the provider or facility.

It is another object of the present invention to provide a computer system operative in connection with an ad network which generates semi-custom ads, tracks potential recruits and promotes and converts the potential recruits into actual applicants for positions at the healthcare facility or healthcare provider.

### SUMMARY OF THE INVENTION

One embodiment of the computer-based method for recruiting a healthcare professional who uses an internet-enabled device to communicate with a recruitment computer server system via a telecommunications network. The recruitment computer server has a recruitment database. The computer server is alos connected to an ad network deployed over the telecommunications network. Initially, the system uploads a cookie onto the healthcare professional's internet-enabled device when the device engages in a telecommunications event with the recruitment computer server system. The recruitment computer gathers the browser history from the professional's internet-enabled device either directly or through the ad network whenever the internet-enabled device engages in a telecommunications event with either the recruitment computer server system or the ad network. The system saves and logs the browser history unique to the healthcare professional into the recruitment database. The browser history is associated with either a unique healthcare professional identifier or an internet-enabled device identifier. The system also creates a custom internet ad unique to either the healthcare professional, unique to a professional field for the healthcare professional or unique to a geographic location for the healthcare professional. The system also creates a healthcare professional webpage, unique to either the healthcare professional or unique to a professional field for the healthcare professional or a geographic location unique to the healthcare professional. A hyperlink is inserted into the custom internet ad. The hyperlink points to the healthcare professional webpage. The system delivers the custom internet ad to the internet-enabled device based upon detection of the cookie when the internet-enabled device engages in a telecommunications event with the ad network. The device displays the ad to the potential recruit. The system also delivers up the healthcare professional webpage due to an activation of the hyperlink. This webpage is displayed to the potential recruit. The system accepts further healthcare professional data from the healthcare professional via the healthcare professional webpage on the recruitment computer server. This computer associates the earlier logged data with the further healthcare professional data.

The recruitment computer includes a processor and a memory which supports the operation of the recruitment computer server, a data portal and a web server portal communicatively coupled to the telecommunications network. The memory contains the recruitment database. As part of the computer, processor and memory, an uploading operation is engaged to place a cookie onto the healthcare professional's internet-enabled device when the device engages in a telecommunications event with the computer via the web server portal. Also the recruitment computer accepts, as part of the computer via the data portal, the browser history either directly or through the ad network whenever the internet-enabled device engages in a telecommunications event with either the recruitment computer server system or the ad network. A storage module stores the browser history in the recruitment database. The browser history is either associated a unique healthcare professional identifier or an internet-enabled device identifier. An ad generator, operative with the processor, the memory and the database, creates a custom internet ad unique to either the healthcare professional or unique to a professional field for the healthcare professional or unique to a geographic for the healthcare professional. A webpage publisher, operative with the processor, the memory and the database, creates a healthcare professional webpage, unique to either the healthcare professional or to a professional field, or a geographic location. The recruitment computer server causes the webpage publisher to effect a display of the webpage upon activation of the associated hyperlink from the ad. A link inserter adds the hyperlink to custom internet ad. The hyperlink points to the healthcare professional webpage. At the web server portal, an input module accepts further healthcare professional data from the healthcare professional via the healthcare professional webpage. The storage module stores the further healthcare professional data in the recruitment database. A matching module associates the browser history and the unique healthcare professional identifier or the internet-enabled device identifier with the further healthcare professional data.

### BRIEF DESCRIPTION OF THE DRAWINGS

Further objects and advantages of the present invention can be found in the detailed description of the preferred embodiments when taken in conjunction with the accompanying drawings in which:

FIG. 1A is a system diagram showing the prior art recruitment system;

FIG. 1B diagrammatically illustrates a single channel communications interaction between healthcare worker HC-W1 and the healthcare provider or healthcare facility;

FIG. 2A diagrammatically illustrates a process diagram utilizing the principles of the present invention wherein multiple internet enabled devices at various times are used by the healthcare professional recruit to interact with the recruitment system;

FIG. 2B diagrammatically illustrates a system in accordance with the principles of the present invention for the recruiting tracker as a trusted third party (TTP);

FIG. 2C diagrammatically illustrates an example of the recruit tracking database or spreadsheet (a two-dimensional datable);

FIGS. 3A, 3B and 3C and 3D diagrammatically illustrate a process flowchart for the multiple channel tracking system in accordance with the principles of the present invention;

FIG. 4A diagrammatically illustrates a method and a process for a re-targeting program;

FIG. 4B diagrammatically illustrates a voice call-in program;

FIG. 5 diagrammatically illustrates a customized web page for a healthcare worker, configured in this embodiment, as an initialized the application process (other types of custom or semi-custom web sites or landing pages may be used);

FIG. 6 diagrammatically illustrates a process and a method wherein the healthcare worker completes the application;

FIG. 7 diagrammatically illustrates the utilization of third party healthcare professional data providers which are integrated into the recruitment system;

FIG. 8 diagrammatically illustrates the processing method for third party database integration program;

FIGS. 9A and 9B diagrammatically illustrate the touch based recruitment program in accordance with the principles of the present invention.

### DETAILED DESCRIPTION OF THE PREFERRED EMBODIMENTS

The present invention relates to a computer based method and a computer system for recruiting healthcare professionals who use interne-enabled devices. Similar numerals designate similar items throughout this patent specification. Also, reference herein to “a healthcare professional” is any person who works in the healthcare field including, but not limited to, doctors, nurses and other qualified individuals, without regard to professional licenses. Reference to a “healthcare facility” includes a healthcare provider. Therefore, a group of doctors who provide healthcare services are generally referred to herein as a healthcare facility. Also, although reference is made in the drawings and in this detailed description to “a hospital”, this recruitment method and system is not limited to hospital setting. Any healthcare facility or healthcare provider may employ the recruitment method and the recruiting system described herein. Additionally, certain abbreviations used in the drawings and in the specification are listed near the end of this patent specification. These abbreviations are sometimes used in the patent specification and are used in the drawings.

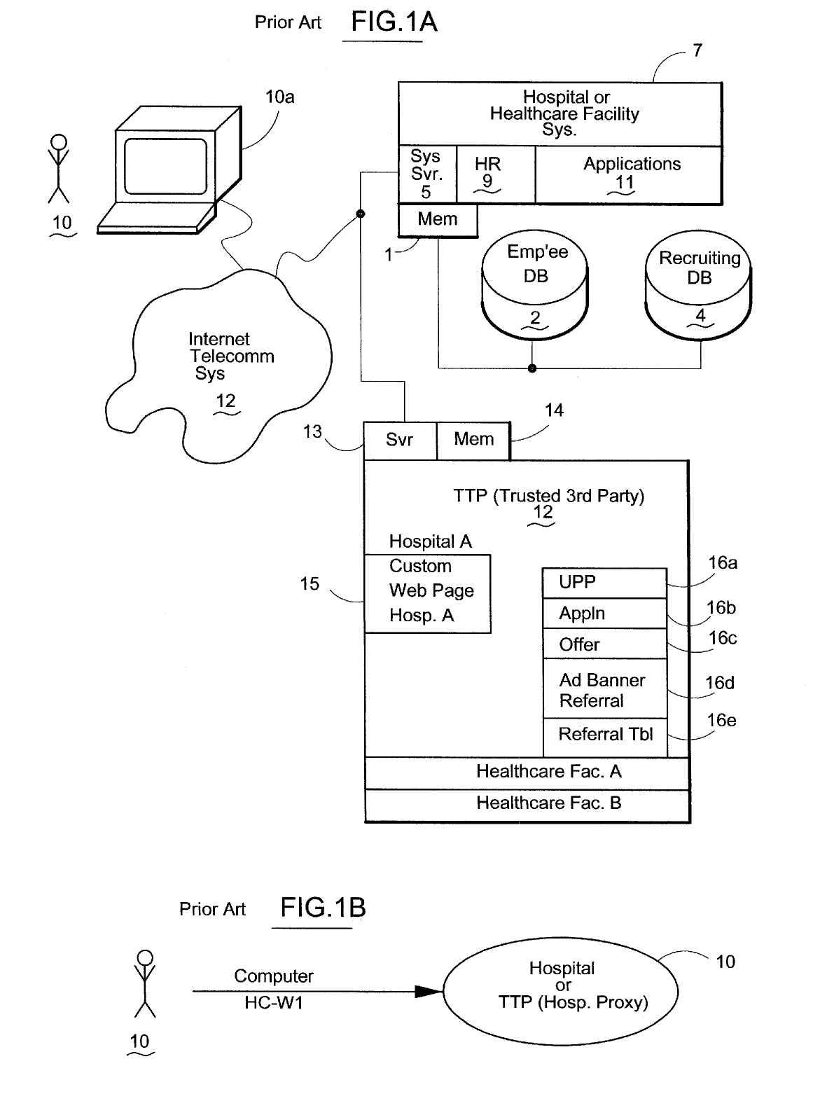

FIG. 1A and FIG. 1B diagrammatically illustrate the prior, art system. A healthcare worker 10 using a laptop or desktop computer 10a, communicates via internet or telecommunications system 12 with a hospital or healthcare facility 7. The healthcare facility 7 has a computer system which has a system server 5. The healthcare facility computer system also includes, as an example, a human resources database or spreadsheet which assists the management to monitor and control the employees and independent contractors at the healthcare facility. Typically, there is a separate database 11 for healthcare professional applications (recruitment database). The human resources HR data and the healthcare professional application data is typically stored in memory 1. Additionally, the employee database 2 and a recruiting database 4 is utilized by the healthcare facility computer 7. The healthcare (HC) facility computer 7 is coupled to the internet or telecommunications system 12 as is the trusted third party TTP 12 computer system.

The TTP computer system 12 includes a server module 13 and a memory 14. Customarily, the TTP 12 is operated by a recruitment organization retained by the healthcare facility to locate HC professionals. To do this, the recruitment TTP 12 has a special designated area in its computer system memory for its client, Hospital A. In this manner, recruitment TTP 12 develops a custom web page for hospital A, shown as web page 15 in FIG. 1A. Further, in some instances, the healthcare facility would contract with the TTP recruitment group to gather information regarding HC worker 10. Therefore, the recruitment TTP computer 12 includes a memory and a database for: the user's personal profile (UPP) 16a, the prospective recruit's application for the healthcare facility 16b, a block or memory location in the database for any offer made or accepted or rejected 16c, and ad or banner referral tracking module 16d and a referral table 16e. In other words, the HC worker 10 somehow locates the healthcare facility and the computer sends a custom webpage for hospital A (custom page 15) to the enabled device. The webpage is displayed to HC worker 10. The HC worker upon activation of an hyperlink in the web page 15 is directed to server portal 13. HC worker 10 is then prompted to complete a user's personal profile (UPP) 16A and then complete application 16b. This information is then transmitted via telecom system 12 to the healthcare facility 7 and more particularly into recruiting database 4. The healthcare facility then decides whether to make an offer or not. This alters the status condition of offer field 16c in the recruiting database 4. The recruitment TTP 12 also tracks how the HC worker 10 arrived at custom web page 15 for hospital A. Therefore, field 16d, the ad banner referral field, gives an indication of how HC worker 10 located the healthcare facility and custom web page 15. The Referral Table 16e is simply a pull-down menu selection or a radio button selection or a pull down list which the user selects to identify any referrals to the HC Facility 7. In other words, sometimes HC worker 10 is referred to a particular hospital or healthcare facility by a person, by an ad or by a job fair. The recruitment TTP 12 needs to track this referral.

Although reference is made to HC worker 10 herein, the worker may be any type of healthcare professional.

It is also common for the recruitment TTP 12 to represent several different healthcare providers or healthcare facilities. However, these healthcare facilities may be in different regions of the country of may not compete against each other in a particular geographic region. As a best business practice, the TTP Recruitment system should not represent two competitors in the same market. Therefore, although hospital A is shown on custom web page 15, the recruitment TTP 12 may have a different memory section for healthcare facility A (which is different than hospital A) and healthcare facility B.

FIG. 1B basically shows a single channel communications process in the prior art. Worker 10 communicates via a computer to a hospital or TTP wherein the TTP is a proxy for the hospital. In this patent specification, all references to a “hospital” are meant to refer to any type of healthcare provider or healthcare facility. The TTP is a proxy for the hospital. In other words, HC worker 10 when he or she lands on custom web page 15, does not know whether that web page is sponsored or served up to computer 10a by system server 5 which is part of the healthcare facility computer 7 or whether web page 15 is served up by TTP server 13. Hence, the TTP computer 12 is a proxy or stand in for the hospital computer 7. This is a common practice in the industry.

It should be noted that persons with ordinary skill in the art recognize that a large portion of the activities and the processes executed by the recruitment TTP can be incorporated within the healthcare facility computer 7.

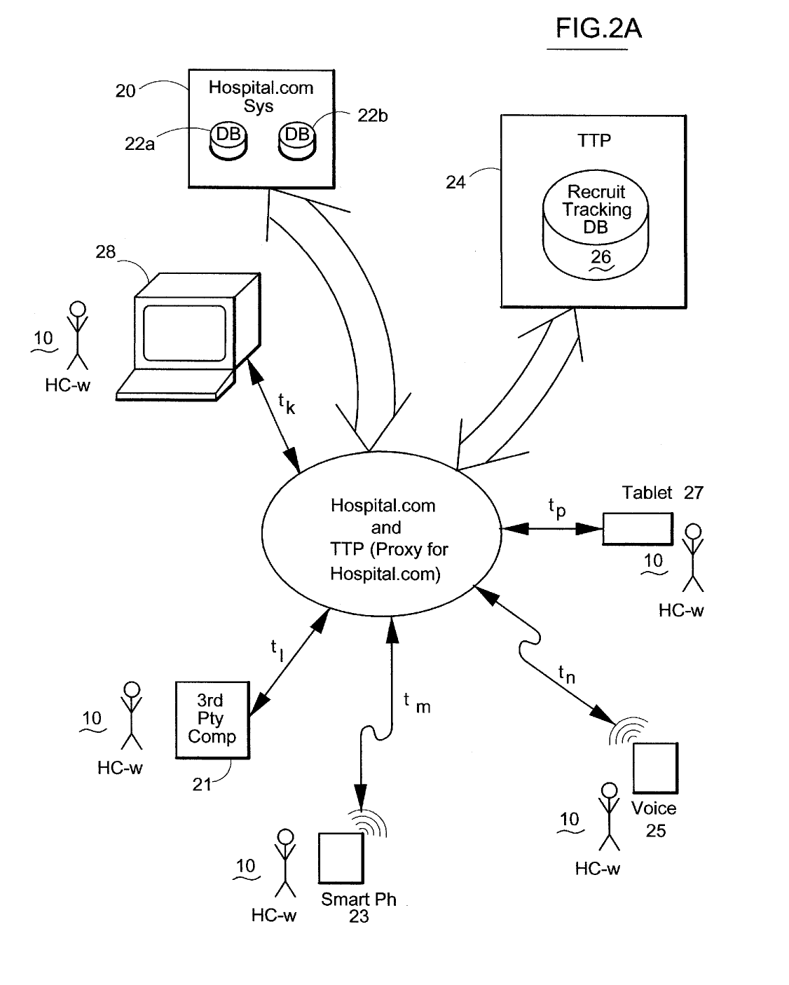

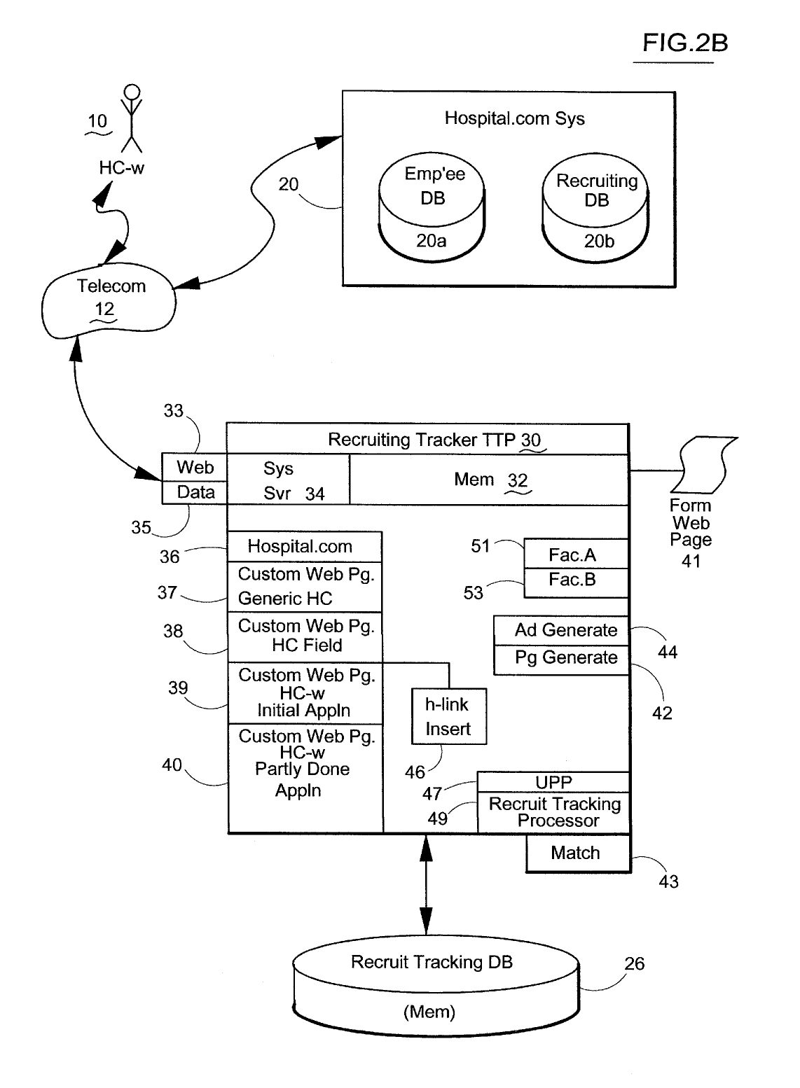

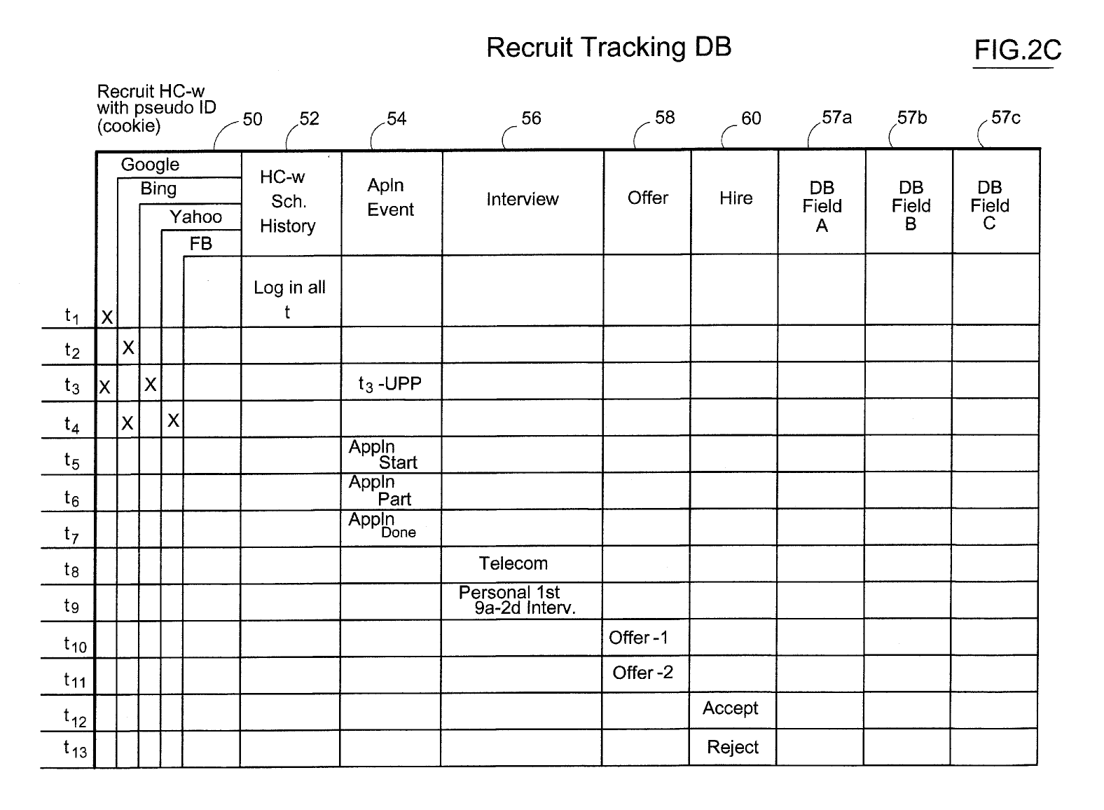

FIG. 2A diagrammatically illustrates a process diagram showing the general principles of the present invention wherein healthcare worker HC-W 10 at various times can use various different internet enabled devices to communicate with a specific healthcare facility or healthcare provider or the recruitment TTP. The specific healthcare facility or healthcare provider is shown in the drawings as a specific example of a single facility or provider, by the label “Hospital.com.” Reference to “Hospital.com” refers to a specific healthcare facility or healthcare provider. Further, with respect to FIG. 2A, the time periods tk through tp are not sequential. Therefore, time tin could be prior to or subsequent to time tk. In any event, the healthcare worker HC-W 10 may use a desktop computer 28, a third party computer 21, a smartphone 23, a voice communications via cell phone 25 or a tablet computer 27. the third party computer is a computer or a computer system owned by another, such as the HC-W's current employer. As is known in the industry, each one of these internet enabled devices has a different IP address when it accesses the internet. When the internet enabled device communicates with the Hospital.com server or the recruitment TTP computer server, the server can capture the IP address for the internet enabled device which is communicatively engaged with the server. As is known in the industry, if a HC-W is using a local area network coupled to third party computer 21, the router for that local area network has a certain IP address. This router IP address is detected by the Recruitment TTP system.

FIG. 2A also notes that the Hospital.com system 20 includes an employee HR database 22a and recruitment or prospective employee database 22b which accepts and processes applications for employment at the Hospital.com. The recruitment TTP 24 includes a recruiting database 26. Data is exchanged between databases 22b and 26 as needed to accomplish the objectives of the present invention.

FIG. 2B diagrammatically illustrates both a recruiting tracker TTP 30 computer system and a Hospital.com computer system 20. Employee database or HR database 20a and recruit application database 20b is generally located in Hospital.com computer system 20. Computer database 20b may have information regarding offers made and interview notes and other pre-employment information for a particular HC recruit. When that recruit is hired and accepts employment at Hospital.com, some information from recruiting database 20b is transferred to employee or HR database 20a. HC worker 10 utilizes telecommunications system 12 to communicate with Hospital.com computer system 20 and recruiting tracker TTP computer 30. TTP computer 30 has a web portal 33 and a data portal 35.

In general, when HC worker 10 engages in an internet based or a telecommunications session with TTP computer 30, the web server portal 33 is utilized. However data transfer from TTP 30 to Hospital.com system 20 may utilize the data portal 35. Although data transfers are generally faster than transfers through a web portal, the comm sessions between the Hospital computer and the Recruitment computer may be through a web portal. Both of these input/output modules (data and web portals) operate over the telecommunications network 12.

TTP 30 includes a system server module 34 and a memory 32 as well as a recruit tracking processor 49. Memory 32 may include one or more spreadsheets and databases. Recruit tracking database 26 is typically included within memory 32. Also, memory 32 would include pre-formatted web pages 41 which are discussed later in connection with the generation of custom or semi-custom web pages. In the memory of TTP computer 30, a designated area is maintained for Hospital.com information. It can be appreciated that Hospital.com has proprietary rights to recruiting data event though the Recruit TTP gathers and processes substantial data for Hospital.com. Both TTP 30 and Hospital.com have rights to the data, subject to contractual obligations.

In the Hospital.com area, TTP 30 has a custom web page which is generic to all healthcare workers 37, and a custom web page which is unique to a field of healthcare workers 38 and designated with the Hospital.com banner headline. As used herein, some examples of a field or a professional field would include nurses in general or, more specifically, emergency room nurses. Therefore, high annual salary personnel or highly specialized personnel may have a semi-custom landing web page which is tailored to his or her field to entice the recruit to apply for the position. In memory space 39, TTP 30 maintains a custom web page for the HC worker 10 as an initial application portal. As explained later, a custom landing webpage may be produced for the single target HC professional. this custom web page may show the recruit's name, among other personal items, again to entice the recruit to apply for a job at Hospital.com. This is discussed later.

In memory space 40, TTP 30 includes a custom landing web page for the HC worker 10 who has partly completed a job application. These applications, when complete, are typically uploaded to recruiting database 20b in Hospital.com computer system 20.

Since recruiting tracker TTP system 30 can provide similar services to other healthcare providers and other healthcare facilities, in memory spaces 51 and 53, data for HC Facilities A and B is maintained, separate from Hospital.com. Contractual obligations may effect how the data is kept separate or how it is combined.

As described later, TTP 30 includes an ad generator 44 and a web page generator 42. When the ad generator 44 is activated, the recruit tracking processor 49 uses hyperlink insertion module 46 to insert into the semi-custom web page (generally identified as “custom” web page HC field 38).

When HC worker 10 wishes to initiate an application and visits the TTP server 30, the HC worker completes a user personal profile UPP 47. The UPP is stored in the database under a unique HC worker identifier. Also as described later, the recruit tracking processor 49 includes a matching module 43 which matches third party professional data obtained from third parties to the HC-W data obtained over the internet. A data list of doctors names and emails form a third party source can be matched to the doctor's UPP or email. A four point data match may be needed to match the HC-W using his or her internet enabled device to known or confirmed HC-W data from a third party data source.

FIG. 2C diagrammatically illustrates the basic structure of a recruit tracking database as a two-dimensional database, typically called a spreadsheet. Of course, a relational database could be used rather than a spreadsheet. In any event, at column 50, the recruiting method and system specifically targets recruit healthcare worker 10 by detecting a pseudo identifier uploaded as a cookie on the HC internet-enabled device when HC worker 10 travels on or communicates with other websites on the internet. Therefore, when the HC worker visits Google at time t1, this information is captured by the database. In time t2, the user has visited the Bing search engine. At time t3, the user has visited Google and Yahoo. Also, these items are all stored in the HC worker search history at column 52. Therefore, all the search engine data and browser history is stored for the internet enabled device carried and used by the HC worker once a cookie is installed on the internet-enabled device. The cookie is installed (uploaded) the first time the HC internet-enabled device visits the Hospital.com server or the Recruit TTP server. At time t3 in column 54, an application event has occurred. At this point, the user has fully or partly completed the LAPP and has started the HC application. At time t5, the HC worker or user has begun the application. At time t6, the partly application has been completed by the HC and the database is updated for this event. At time t7, the application is done. In column 56, an interview is noted at time t8 (a telephone interview), and at time t9, a personal interview is noted. At time t9 A, a second interview is indicated. In column 58, two offers have been made by Hospital.com to HC worker 10 at time t10 and t11. Column 60 is the hire column and at time t12 an acceptance is noted by the system. At time t13 a rejection is noted.

With respect to database fields A, B and C (column 57a, 57b and 57c), these fields are left open to be designated with a field label and populated or filled out by other data resulting from the tracking of HC worker 10 as that worker travels through the internet and telecommunications system to various websites. The following Recruit Tracking Table is an example of the types of additional fields in the recruit TTP database.

Recruit Tracking DB Field Table
geo location HC-W
visits to other HC Fac. Sites
distant geo locations
preferred device (alt. target reminders)
other referral sources in UPP
time differential between events

As an example of additional fields in the recruitment tracking database, the geographic location of the healthcare worker can be identified and stored based upon geographic information obtained from the internet enabled device used by the worker. The system can also track if the worker has visited other healthcare facility sites by storing information regarding browser history. The “distant geo locations” field is an indicator that the HC worker is searching potential jobs in geographically distant locations, that is, distant either from the current internet enabled device or distant as in “away from the current employer” of the HC worker. In other words, since the present recruitment system tracks multiple communication events between the HC worker and websites on the internet, a reasonable assumption can be made if multiple geographic locations are centered in a certain geographic location such as a county or a city, that the HC worker is interested in moving to those different cities or regions. If the web browser history indicates that the HC worker is searching another healthcare facility, other than her current employer, this is an indication that semi custom webpage for that HC worker may be warranted. This is especially true for high value, high annula salary employees. The “preferred device” field is utilized to identify what internet enabled device the HC worker typically uses. By capturing this data, the recruitment computer can target reminders to that particular internet enabled device. In other words, if the user regularly visits his or her FACEBOOK™ account, the recruitment targeting program can present semi custom ads when the HC worker is on his or her FB account, enticing the HC worker to use the Recruitment TTP portal and server. Stated otherwise, if the HC worker typically communicates via the internet while the HC worker is working at a different healthcare facility (other than Hospital.com), the recruitment computer may target those type of events for that internet enabled device. The “other referral source” field is a field which the HC worker completes during the data input event for the UPP indicating that he or she has obtained information from other referral sources for that particular healthcare provider (Hospital.com). The time differential field is also an indication of how interested the healthcare worker is in obtaining new employment. If the recruitment tracking system logs in multiple visits to various healthcare providers in a certain geographic area within a short period of time (for example one month), there is a reasonable likelihood that HC worker 10 is interested in changing positions. Therefore, the recruitment computer can target that HC worker 10 with semi custom ads when the HC worker visits other website on the internet. This micro-targeting of HC workers is an important feature of the present invention.

The Marketing Analysis Table set forth below provides an example of what information is important to healthcare providers and healthcare facilities that utilize the service of the recruitment tracking method and recruitment system. The Recruitment TTP creates these performance ratios and data after a period of time or after certain recruitment milestones are met.

Marketing Analysis Table
Ratio: marketing channel vs. completed applications
Ratio: marketing channel vs. offer made; hires accepted
Cost per channel per offers/hires/applicants
Cost per offer (broken down by HC field)
Cost per hire (broken down by HC field)
Cost per DB purchase per offer/hire

Although prior art systems provide an example of how many healthcare workers click on or select a certain Hospital.com sponsored ad and go directly to the Hospital.com application page (on Hospital.com or a recruitment computer (as a proxy)), that information in only partly useful as a recruitment performance tool. Effectively, many HC-W's click-on the ad but never complete the application and fewer are offers or are hired. The present system utilizes a multiple channel and multiple time factor analysis (and a geo-locator function) to entice the HC-W to complete the UPP and the HC application, and then to compare the cost and benefit of particular marketing channels to the number of offers made to healthcare workers. Another ratio is marketing channel compared with the number of hires accepted by the healthcare worker. Of course, the cost per marketing channel is a factor. The cost per offer is important as well as the cost per offer for a particular HC field (e.g., nursing). The cost per hire is a factor. The cost per database purchase from third party data sources as compared with the number of hires generated and the number of offers generated for that particular cost is a market analytic.

The following Cookie Data Table provides some exemplary information about information that might be logged into a particular cookie. Other technicians have knowledge of the cookie composition.

Cookie Data Table
Time, date
Cookie Expiry time, date
Referral source
Internet enabled device location
Device type
Target hospital or healthcare facility
Browser history algorithm data

As is known in the prior art, internet enabled devices typically accept a cookie when the user visits a certain webpage or web server. These cookies are customized in the case of the recruitment method. The Cookie Data Table above shows some information markers that might be associated with information in the cookie. For example the current time and current date when the cookie is uploaded to the internet enabled device is important. The current time and current date when compared with an earlier cookie upload date provides time differential information useful for the recruitment system and method. The expiration or expiry time and date shows how long the cookie has been on the device. The referral source indicates if the HC worker has been referred from a certain website such as a third party website for particular paid internet advertisement. For example, the Hospital.com facility may engage in Google sponsored ad words and the HC worker may click on one of those Google sponsored ad words and go to an application page or the initial application page at the recruitment computer. In this case, referral source data is important. If the recruit stays on the Hospital.com or proxy TTP-Hospital.com landing web page for a reasonable period of time, this indicates that the HC-W is interested in making an HC application. Therefore, a semi-custom web page can be created for this particular HC-W and served up then next time the HC-W visits the Recruit TTP. The cookie assists in this micro targeting event and process.

When the internet enabled device interacts for the first time with the referral recruiting computer, a cookie is uploaded onto the device. Since the recruitment process described herein can be split between Hospital.com and Recruit TTP, or can be solely on Recruit TTP, then the initial cookie upload can be form the Hospital.com server or the Recruit TTP server. However, the process ultimately is the re-targeting of the HC-W and converting a “person who looks” into an HC applicant.

The internet enabled device location is beneficial if the location is critical to where the healthcare worker desires to work. Device type provides information as to where further reminders and prompts should be sent by the Recruit TTP to the HC worker. The target hospital or healthcare facility is the facility which contracts with the recruitment system (that is Hospital.com) and uses the method to achieve a certain result. Browser history algorithm data provides a brief snap shot of the browser history.

The following Referral Table provides some selections at the initial application stage. the HC-W selects one or more of these common referral sources (maybe a pull-down list).

Referral Table
Internet ad
Friend
Radio
Other
Job fair

In the UPP, the user typically selects a where and how he or she was referred to the recruitment system. This may include an internet ad, a friend, a radio advertisement, other marketing event, or a job fair.

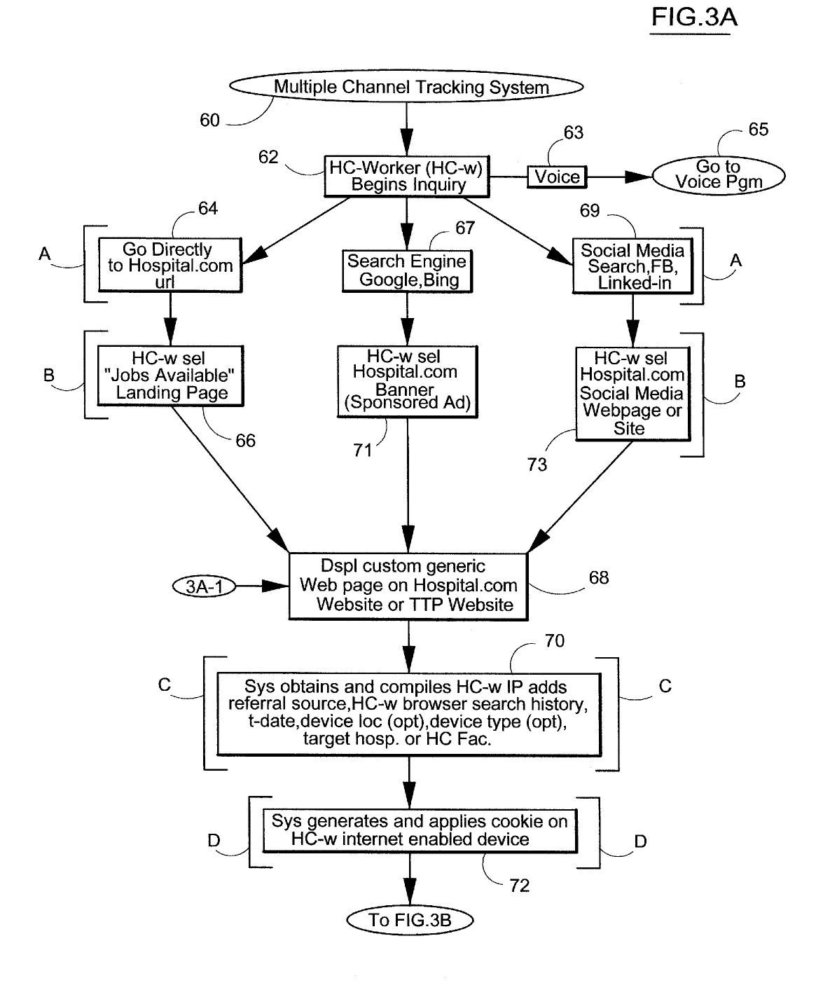

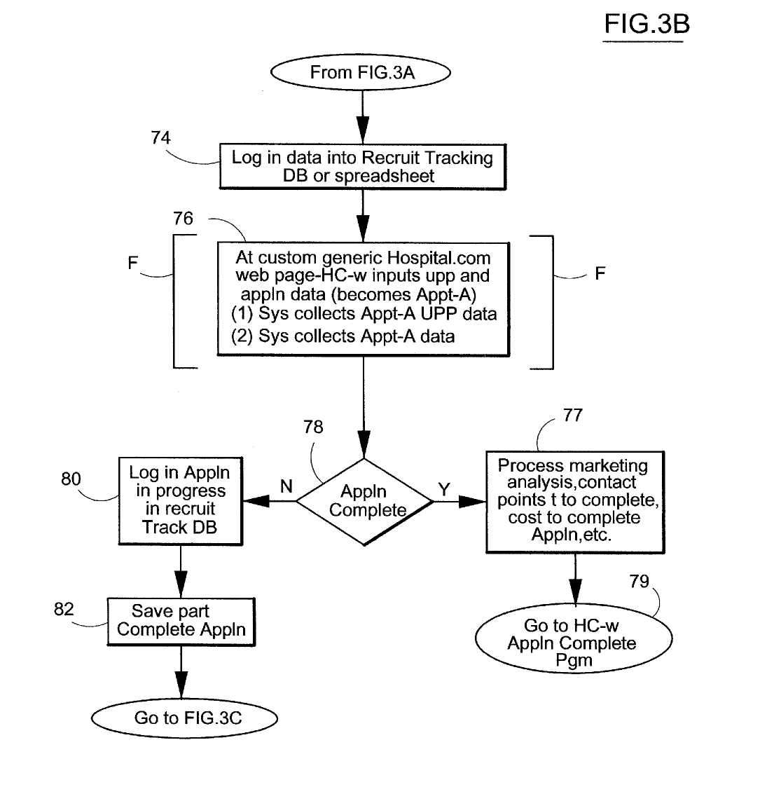

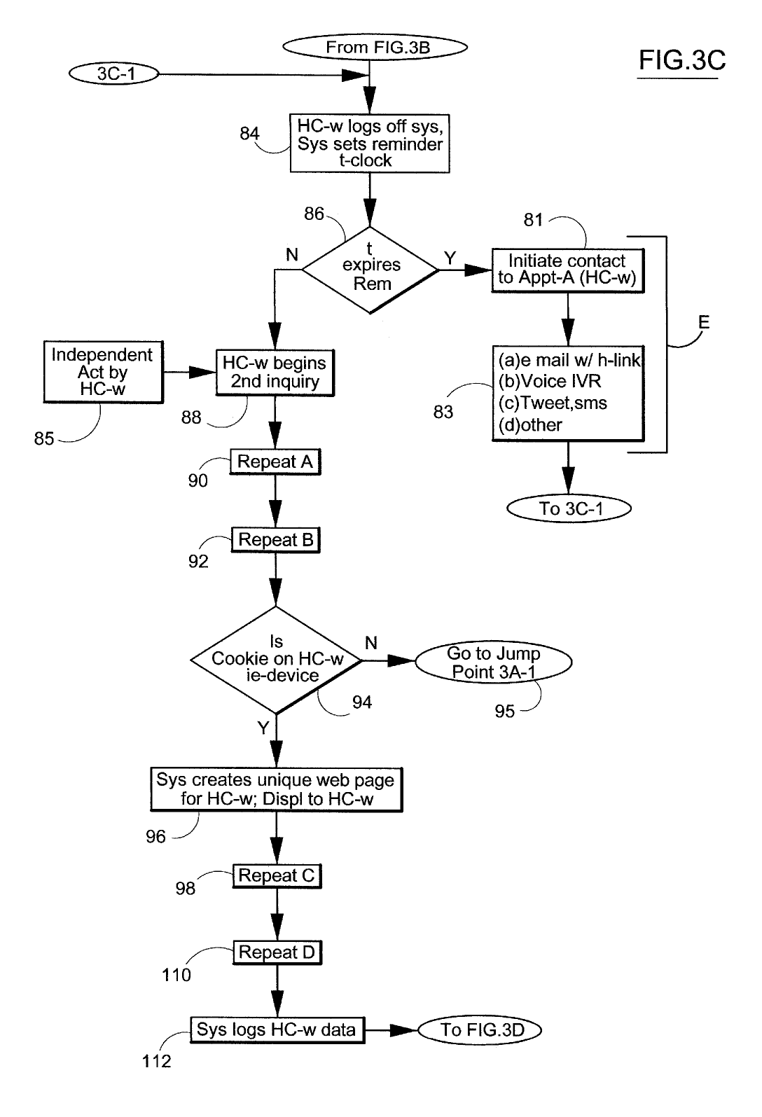

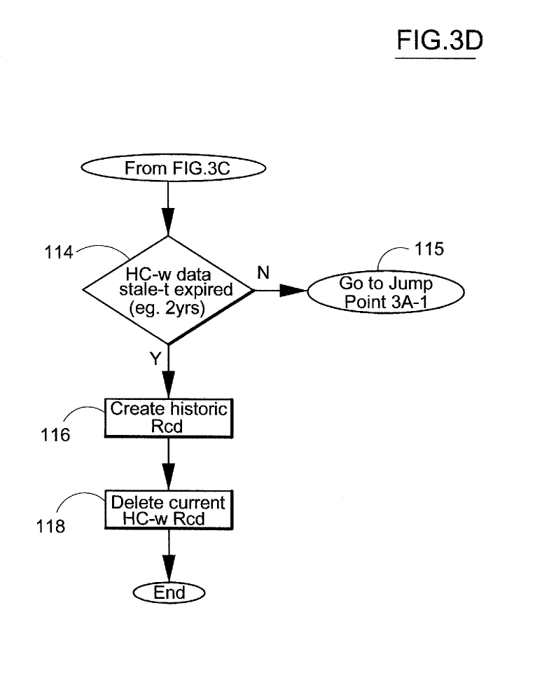

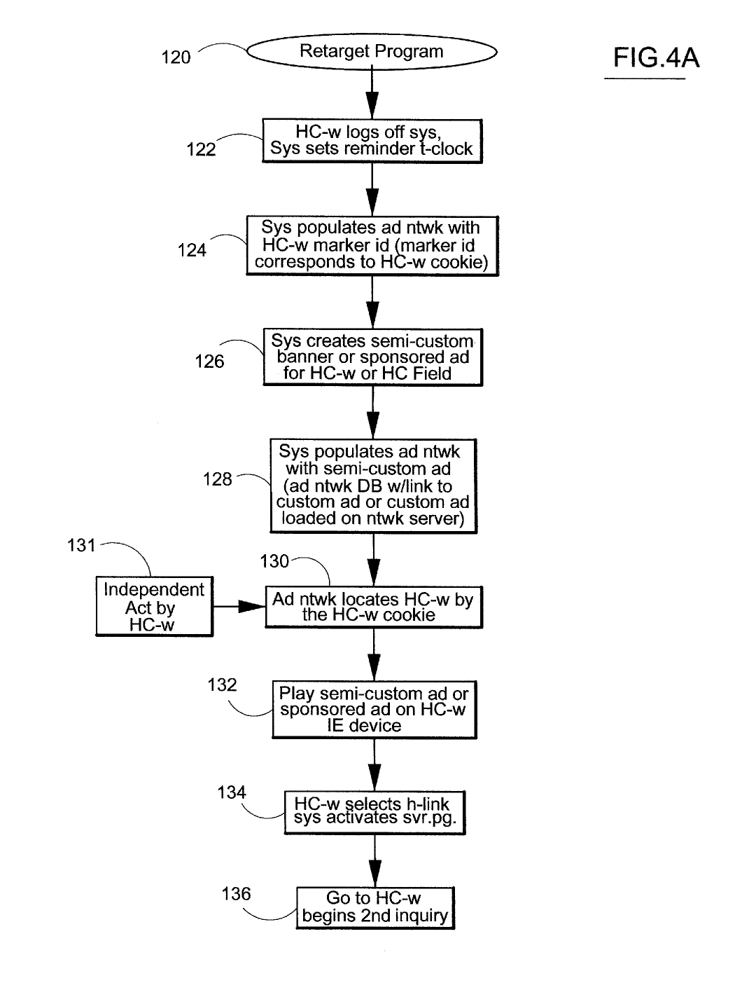

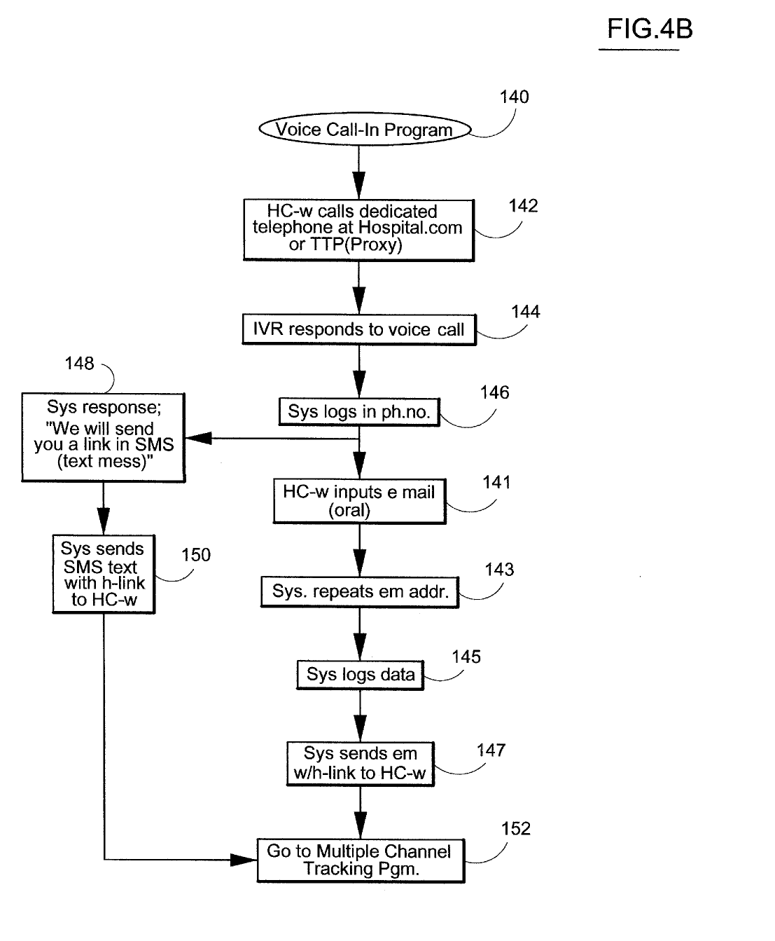

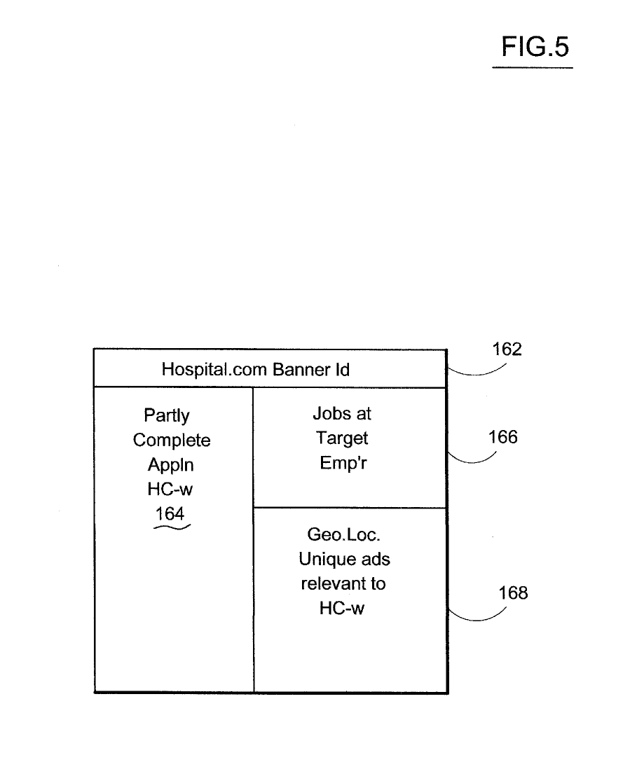

FIGS. 3A, 3B, 3C and 3D diagrammatically illustrate the process and flow for the multiple channel tracking system 60. It should be noted with respect to the multiple channel tracking system and method 60, that the order of the steps may be revised or changed to achieve a more efficient system. Also, certain branches could be omitted and other branches could be added as necessary. In step 62, HC worker begins an inquiry on the internet or a telecommunications system with a telecommunications event with the internet enabled device. Step 63 notes that the HC worker initiates a voice communications and the jump point 65 step transfers the process to the voice program shown in FIG. 4B. Otherwise, HC worker from step 62 may directly visit the Hospital.com website or url in step 64. Thereafter, the HC worker would select “job available” landing page from the Hospital.com website in step 66. Alternatively, the HC worker from step 62 may visit any particular search engine such as GOOGLE™, BING™, YAHOO™, or others in step 67. The worker may select a Hospital.com banner ad or sponsored ad on one of those search engines as noted in step 71. Alternatively with respect to direct communication event 64 or search engine/sponsored ad channel 67, the HC worker may utilize social media in a search such as FACEBOOK™ or LINKED-IN™ in step 69. If operating with the social media channel, the HC worker may select Hospital.com social media webpage (triggered by a social media ad) or FB site in step 73. All of these comm channels activate step 68 which displays a custom-generic web page on Hospital.com website or the recruitment TTP website. The term “custom-generic” refers to a generic web page generally directed to healthcare professionals that has been customized for Hospital.com. The Hospital.com banner may appear at the top of the “custom-generic” web page without regard to whether that web page is served up by the TTP server or by the Hospital.com computer server. See banner 162 in FIG. 5.

In step 70, the system obtains and compiles the HC worker's internet protocol IP address, that is, a unique marker associated with the internet enabled device, any referral source data (Hospital.com, url, GOOGLE™, FACEBOOK™), the browser search history for the HC worker, the date and time of the communications event, potentially a location of the internet enabled device, potentially the type of device utilized by the HC worker and also identifies the target hospital or HC facility who is the client of Recruit TTP. In step 72, the system generates and applies a cookie on the HC internet enabled device. This cookie is discussed earlier in connection with the Cookie Table.

Turning to FIG. 3B, in step 74, the system, and particularly the recruitment tracking system, logs the data into the recruit tracking database or spreadsheet. A unique HC identifier is used, either the internet-enabled device IP address or a unique HC professional identifier. As noted later, sometimes the name of the HC-W is known. At other times, a device id is used to track the HC-W's internet-enabled device over the internet.

Since the HC-W has landed on the Hospital.com webpage (a generic “fill-in the UPP and application data webpage), step 76 accepts HC worker data for the worker's UPP at the custom generic Hospital.com web page. In other words, the HC worker has initiated the application phase for the applying for the job or position at Hospital.com. The application data (now the HC worker becomes applicant A), is collected from the HC-W. The system collects UPP data from the applicant and application data form the applicant as generally required by the Hospital.com or other healthcare facility or healthcare provider). In step 78 the decision is made whether the application is complete or not. If the application is complete, the YES branch is taken.

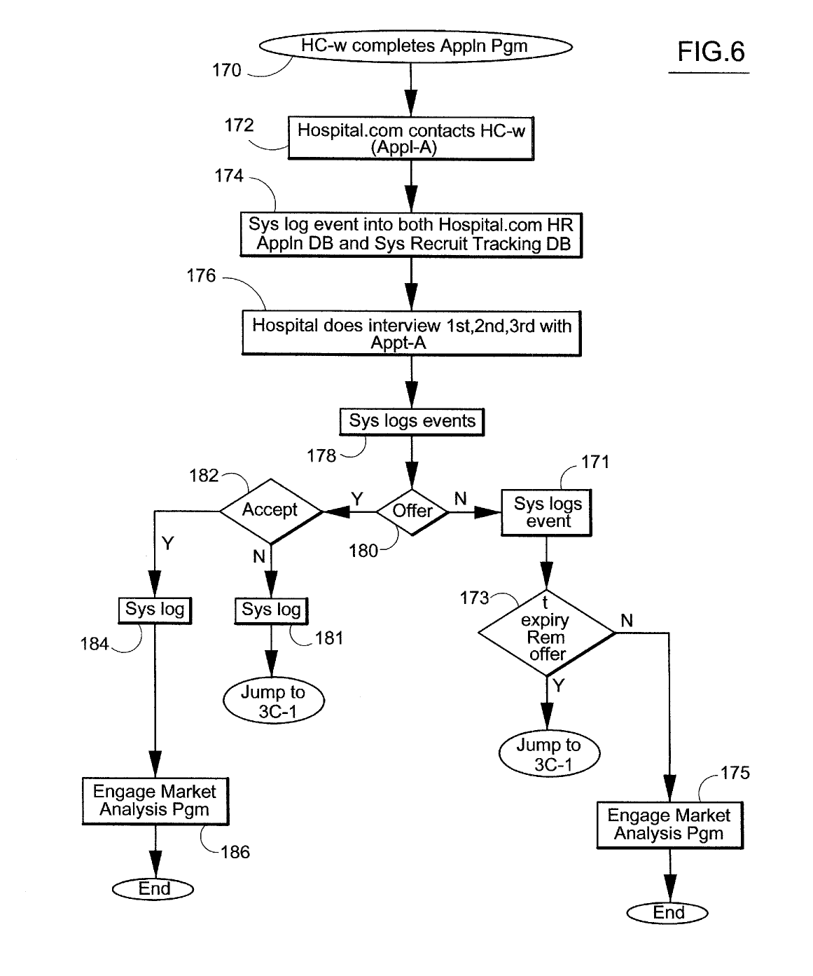

In step 77 an analysis is made of the marketing efforts by the recruitment model. The number of touch or connect points or communications events is analyzed in comparison with any offer made by Hospital.com. The time to complete the application indicates the speed or desire to get the new position. It may also indicate how busy the professional is if the professional is a high value/high pay level professional (a doctor). The Hospital.com “cost to complete the application” and the other market analysis data is compiled as discussed above in connection with the Marketing Analysis Table. In step 79, the system goes to the Application Complete program which is FIG. 6.

If the application is not complete, the NO branch is taken from step 78 and in step 80 the partly completed application is logged into the recruiting tracking database. In step 82 the partly completed application is saved.

With respect to FIG. 3C, in step 84, the healthcare worker logs off the system, and the system sets a reminder time clock. Decision step 86 determines whether the reminder time clock has expired. If YES, in step 81, the system initiates a contact with the healthcare worker. The reminder is sent to the internet-enabled device either (a) identified by the HC-W in the UPP or (b) the device typically used by the HC-W during his or her travels over the internet.

In step 83, an email is sent to HC-W and the email has embedded therein a hyperlink which points back to the partly completed application page. Also, the system and method creates a custom website page for the healthcare worker who has partly completed the application. The email has hyperlink to that web portal on the Recruit TTP which portal serves up the custom landing page unique to the HC-W for the partly completed application for HC 10.

Additionally, or alternatively, a voice interaction event could be conducted with the healthcare worker. In other words, an interactive voice response (IVR) module could be triggered sending a recorded telephone call to the cell phone, smartphone or land line of the healthcare worker. In subset c, a tweet message or sms text message is sent by the recruitment tracker to the HC worker. Other communications events could be activated.

Returning to decision step 86, if the reminder time has not expired, the NO branch is taken and the system executes step 88. In that step, the HC worker begins a second inquiry as an independent event per step 85, that is independent of the Recruitment TTP system. This independent action could include a search on GOOGLE™ or BING™ or a search in social media. In this situation, the system repeats one or more block step A (FIG. 3A) and then block step B.

In step 94, the system determines if a cookie has been detected on the internet enabled device used by HC worker 10. If not, the system in step 95 returns to jump point 3A-1 at step 68 which displays a custom-generic web page for Hospital.com. If a cookie is detected from step 94, in step 96 the system creates a unique web page for the HC worker (a semi-custom webpage) and displays that unique web page to the HC worker. As stated earlier, a semi custom web page could be designed for (a) the field within which falls the professional or (b) a unique web page just for the HC professional. Since the browser history has been obtained from a previous contact with the HC worker (see steps 68, 70, 72), there is a cookie on HC worker internet enabled device. Further, the recruitment tracking database has information regarding the previous browser search history from the internet enabled device. It is possible to conduct a subject search for key words through that browser history in order to determine the type of HC professional and the field for the HC professional. If, for example, the HC professional is a nurse, then the “nursing field” semi custom web page can be created by using standard format webpages, and then adding the nursing field data. The semi-custom webpage is stored in the recruitment TTP computer system. The identifier for the semi-custom webpage is both the cookie as well as the type or IP address for the internet enabled device. Also, the healthcare professional web page could be unique to the healthcare professional or unique to the professional field for that healthcare professional or unique to the geographic location of the healthcare professional (page displays “Looking for a job in Cleveland?”). A custom internet web page is unique to a particular healthcare professional if a reasonable match is established that the internet enabled device data and the browser history matches similar data obtained from third party providers (discussed later)(a four data point match). As for a healthcare professional web page unique to a professional field, if the worker is a nurse, and the browser history previously identified that the nurse was looking at other nursing jobs at other providers or facilities, then the unique healthcare professional web page could be created and designed for nurses. A geographic web page is unique to either where the HC worker was looking for new employment as determined by the browser history or unique to a localized work region (e.g., New York City).

In addition to creating a unique healthcare professional web page, the system also creates a custom internet ad. The internet ad (I-ad) is either (a) unique the healthcare professional, (b) unique to a professional field for the healthcare professional or (c) unique to a geographic location associated with the healthcare professional (a local or a distant region). The generation of an I-ad (discussed later) includes insertion of a hyperlink pointing to the unique healthcare professional web page such that: (i) the ad triggers an association in the HC worker's mind and (ii) spurs the worker to select (click-on) the ad and activate the hyperlink (a sponsored ad or banner ad) which then (iii) transfers the internet enabled device to the TTP semi custom or HC custom recruitment web page. In this manner, the conversion rate for recruits is much higher because the marketing efforts are targeted to a particular recruitment person such as with targeted ads and especially designed professional web pages. Of course, step 96—the creation of the web page and the creation of the internet ads—could occur immediately after step 70.

In step 98, the system repeats block step C and in step 110 the system repeats block step D. In step 112, the system logs in additional HC worker data as discussed earlier in connection with data gathering step 70.

FIG. 3D begins with decision step 114 which determines whether the gathered HC data is stale. In other words, is the “time since last contact” greater than a predetermined expiration time (the last time the HC worker visited the recruitment TTP web portal). If NO, the system goes to jump point 3C-1 and step 84. If YES, the system executes step 116 which creates a historic record of the HC worker data (an archiving step). In step 118, the system deletes the current HC record data.

FIG. 4A is Retargeting Program 120. In step 122, the worker logs off the system and the system sets a reminder time clock. In step 124, the system populates a third party ad network with the HC worker marker id. The marker id corresponds to the HC worker cookie previously uploaded by the recruitment computer onto the internet enabled device. A brief description of ad network is found near the end of this specification near the abbreviations table. Effectively, the ad network is one or more companies which provide advertising channels to vendors or service providers for the sale of goods or services. Typically, the recruitment method and program will design a banner ad or sponsored ad and place that banner ad or sponsored ad on an ad network server or multiple ad network servers. When the HC worker travels about the internet and visits many websites, some websites detect the cookies on the internet enabled device. If a server within the electronic system of the ad network detects the HC worker cookie, the ad network serves up the semi custom sponsored ad to the internet enabled device. This sponsored ad has an embedded hyperlink therein which, if selected by the user, transfers the user's browser to the recruitment computer and, more importantly, to the custom web pages 38, 39 or, if HC-W has partly completed an application online, to Applicant custom web page 40 in FIG. 2B.

It should be noted that the ad network may also capture the HC-W browser history and transmit that history to the Recruitment TTP. This could be through the data portal or the web-based portal, whichever is established by the ad network.

Returning to step 124, the system populates the ad network with programs to identify the cookie placed on the internet enabled device for the HC worker. In step 126, the system creates a semi custom ad or sponsored ad for the HC worker particularly or for the HC field or for a geographic location desired by the HC. The geographic location of the HC may be where the HC is currently working or may be a different geographic location where the HC is interested in working. By careful review by subject matter contacts and content of the browser history, the recruitment marketing computer and method can customized the internet ad as well as the custom web page. In step 128, the recruitment system populates the ad network with a semi custom ad. The ad network database has a link to the recruitment custom ad or the custom ad is loaded on the ad network server. In other words, it is possible that the ad network has a pointer which pulls the custom ad from the recruitment system and serves it up when the ad network detects a cookie on the internet enabled device.

In step 130, the ad network locates the HC-W by the cookie on the internet enabled device. The ad network detects the cookie on the device. Step 131 notes that this is an independent act by the HC worker, in other words, the HC worker visits a website which has a contractual relationship with the ad network. The website looks for the cookies on the internet enabled device, notifies the ad network of the existence of a particular cookie and the ad network serves up a semi custom I-ad to the internet enabled device carried by the HC worker. In step 132, the semi custom ad is played with displayed or the sponsored ad is played on the HC-W's display of the internet enabled device. In step 134, the worker selects the hyperlink in the semi custom or sponsored ad which activates the server landing page on the recruitment tracking TTP computer system.

In step 136, the HC worker begins the second inquiry process from the channel tracking program. This “second inquiry process” refers the process back to “second inquiry” step 88 in FIG. 3C.

FIG. 4B is Voice Call-in Program 140. In step 142, the HC worker calls the dedicated telephone number at Hospital.com or the recruitment TTP which acts as a proxy for its client Hospital.com. In step 144, the interactive voice response (IVR) at the TTP server responds to the worker's voice call and request for additional information. In step 146, the system logs in the phone number of the HC-W into the recruitment database. This is a contact point data for the HC-W. The operation then splits. In step 148, the system responds that the system will send HC-W a link in a text message for activating the semi custom web page. In step 150, the system sends the sms text message with a hyperlink to the internet enabled device for the HC worker. Alternatively from step 146, the system in step 141 permits the work to input an email address. This is another contact data point for HC-W in the recruitment database. This email input may be an audio input or may be a keypad input of an email address. In step 143, the system repeats the email address to the caller. In step 145, the system logs in the email address into the database. In step 147, the system sends an email with a hyperlink to the healthcare worker. The email is a pre-formatted email which is partly filled in with additional data unique to the HC worker (a hyperlink to the semi-custom HC webpage). In step 152, the system returns to the multiple channel tracking program in FIG. 3A.

FIG. 5 diagrammatically shows an example of a web page. In region 142, a banner identifier for Hospital.com is shown. This web page is used as a basic format for custom web pages 37, 38, 39 and 40 in FIG. 2B. In region 164, the HC worker has partly completed the application web page 160. In region 166, “jobs open at the target employer,” Hospital.com, are shown. In region 168, geographically unique advertisements are provided to the HC worker. For example, these may be ads for professional uniforms, professional equipment, local restaurants, rental houses near Hospital.com, etc. Although in region 164 a partly completed application is shown, the web page 160 could be utilized for the custom web page for the HC field 38 or the custom web page for the initial application for the HC worker 39.

The following Relevant Ad Table shows the type of ads which could be placed in region 168.

Relevant Ad Table
Rental housing near Hospital.com
Similar jobs near Hospital.com
Condition of schools
Typical local salaries for others in HC field
Houses for sale near Hospital.com
Local income tax calculator
Cost of living data (localized)

In FIG. 6, the Application Complete program 170 is shown. Step 172 indicates that the Hospital.com has contacted healthcare worker which is sometimes called herein Applicant A. In step 174, the system logs the event into the Hospital.com human resources HR application database and in the Recruit Tracking database. The recruit tracking system is utilized to provide analytics to validate the expense and ascertain the best advertisements and custom web pages to attract high quality HC workers. The application data is stored in the Hospital.com application database because the Hospital.com is more interested in the applicant and processing additional information for the applicant. Although the application may be gathered by the Recruit Tracking computer and then transferred, ultimately, the data is gathered from the HC-W and then uploaded to Hospital.com.

In step 176, the Hospital interviews the applicant a first, second and third time. In step 178, the system logs these recruitment events into the databases. The Recruit database needs this data to compile the marketing analytics discussed earlier. Decision step 172 determines whether or not an offer is made. If not, the system logs a “no offer event” in step 171. In decision step 173, the system determines whether a time has expired between the no offer event and a predetermined time. If YES, the system jumps to FIG. 3C-1 which is immediately prior to step 84. If the time has expired from decision step 173, in step 175 the system engages a market analysis to determine the effectiveness of the marketing program and the sponsored ads and the specially configured web pages.

Returning to step 180, if an offer has been made, decision step 182 determines whether the worker has accepted the position. If not, the system in step 181 logs in the “no accept” event and then returns to jump point 3C-1.

If the offer is accepted in step 182, the system logs that event in step 184. In step 186, the system engages in a market analysis program.

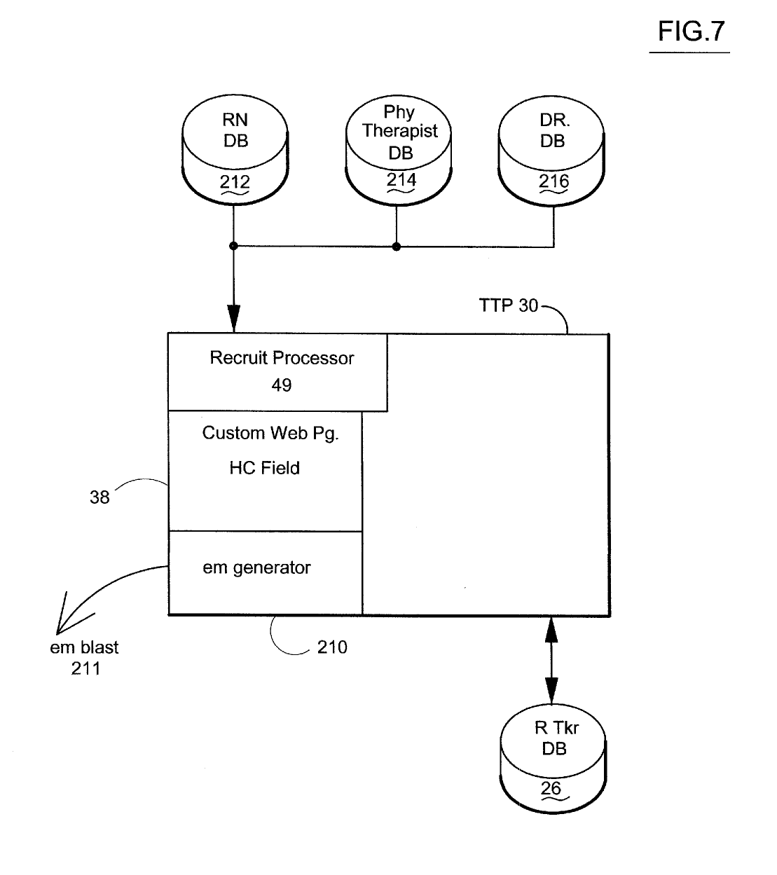

FIG. 7 diagrammatically shows the system requirements when the recruitment tracking program accepts data from other third party data sources. The recruitment TTP 30 may purchase or otherwise obtain HC contact data from nursing database 212, from physical therapist database 214 and from doctor database 216. Typically, this data is purchased. This information from third party sources of healthcare professional data is uploaded into recruitment tracking database 26. The recruitment processor 49 transfers the data and populates the correct spreadsheets and databases in database 26. Functional block 38 involves the generation of a custom web page for a particular healthcare field (for example, nurses). Email generator 210 sends out an email blast 211 to these third party professionals (nurses). The emails have an hyperlink in the email body which, if selected by the user, transfers the user to custom web page 38 (a semi custom webpage for Hospital.com nurses). In this manner, specific direct targeting of healthcare professionals is provided. Further, that data from third party sources typically includes the name, geographic location and email address and phone numbers of the professionals. This third party data is useful to the TTP since the Recruit TTP can combine this data with the browser tracking information and the other information discussed above in connection with healthcare worker 10. A four point match between third party data and the HC-W internet-enabled device data is adequate to create a semi custom webpage and micro targeted sponsored ads.

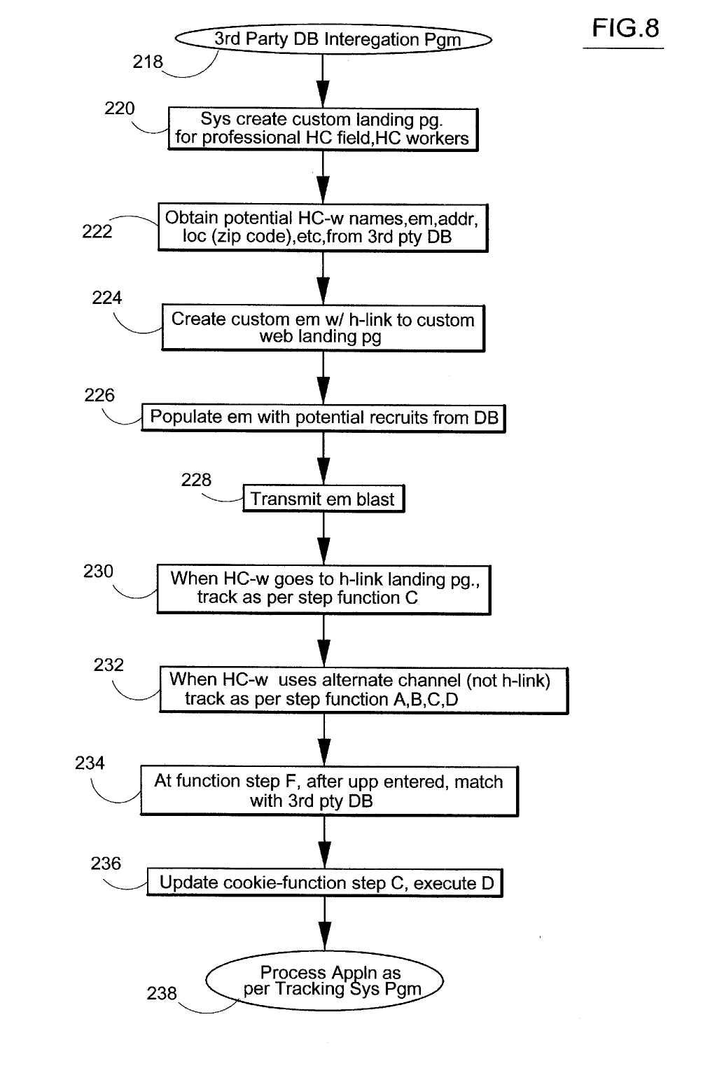

FIG. 8 is a Third Party Database Integration program 218. In step 220, the system creates a custom landing page for a professional HC field or for certain HC worker. In step 222, the system obtains potential recruits names, email, addresses, location (for example, zip code) from the third party databases. See FIG. 7. In step 224, the system creates a custom email with hyperlink to a custom web landing page. In step 226, emails are populated or created for each potential recruit from the purchased data from the third party databases. In step 228, the emails are blasted out and directed to potential recruits. In step 230, when the HC worker selects the hyperlink in the email, the HC worker is transmitted to the custom landing page. Thereafter, the HC worker is tracked as indicated at functional step block C in FIG. 3A.

In step 232, if the HC worker uses an alternate channel (not hyperlink channel from the email), the HC worker is tracked as indicated by step block functions A, B, C and D in FIG. 3A.

In step 234, at function block step F, after the HC worker enters his or her UPP data, a final confirming match is made between the third party data and the UPP data entered by the HC worker. The recruit database has a “match factor” field to ascertain whether a special webpage for a particular HC-W is warranted (used) or whether an HC field webpage should be used. In step 236, a cookie is upgraded in function step block C. This cookie is created, executed and installed in function block step D. In step 238, the application is processed in accordance with the tracking system program discussed above.

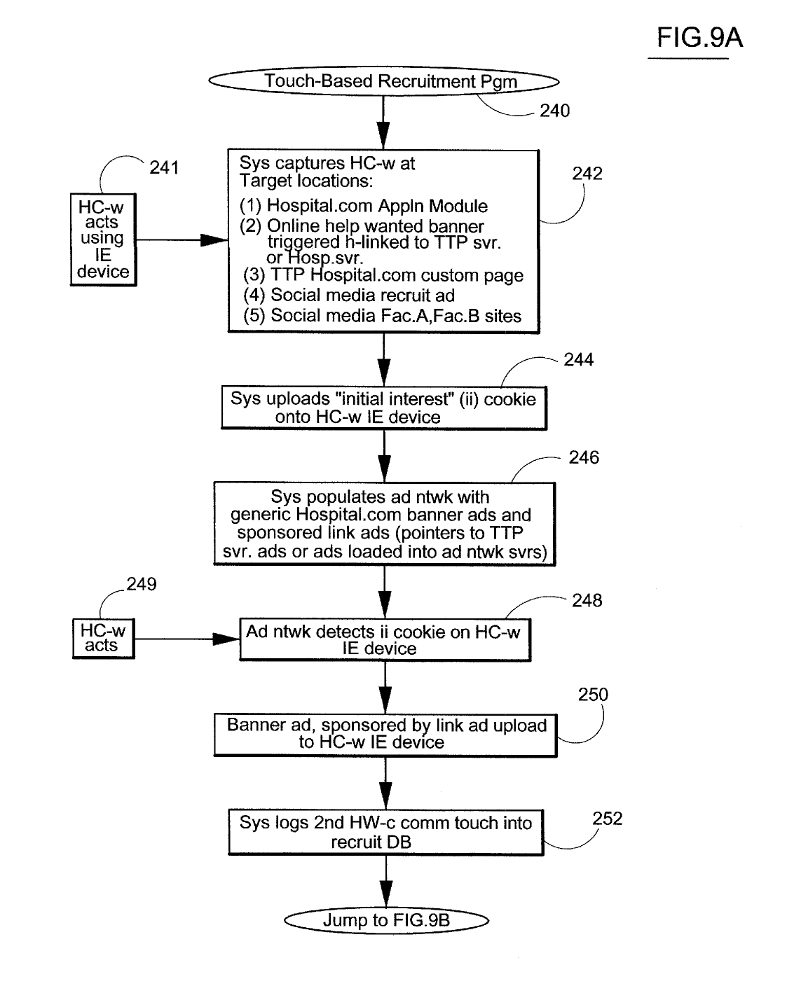

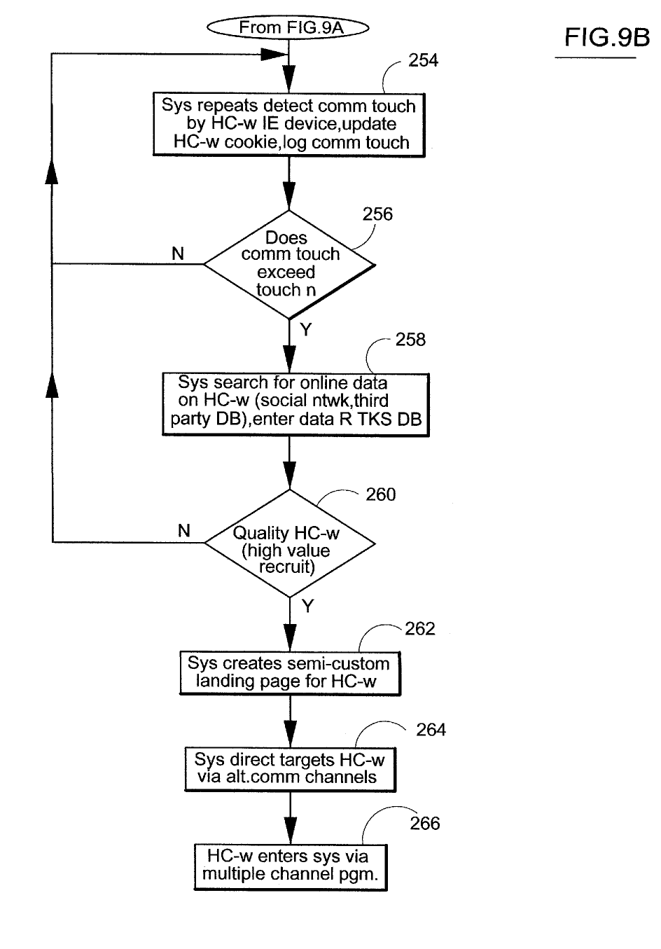

FIGS. 9A and 9B diagrammatically show a touch based recruitment program 240. In step 242, the system captures data for the HC worker at various target locations on the internet. The ad network gathers data and transmits the same to the Recruit TTP. Step 241 indicates that HC worker has acted independently is using his or her internet enabled device. Target locations identified by the recruitment system include the Hospital.com applications landing page, an online help wanted banner, the recruitment TTP Hospital.com custom landing page (generally to all potential recruits, but customized just for Hospital.com); a social media recruitment ad; and a social media page for HC Facility A (not Hospital.com, but a competitor), and HC Facility B social media websites. In other words, the recruitment system is established to detect when the HC visits Hospital.com application module. When that happens, the system, in step 244, uploads an initial interest (i.i.) cookie into the HC worker's internet enabled device. The same thing is true for the HC worker who visits an online help wanted banner. This triggers the upload onto the internet enabled device of an initial interest cookie. The same is true if the HC worker visits the recruitment TTP server unique to the Hospital.com website. If the worker visits a recruiting ad on social media, an initial interest cookie is uploaded. This assumes that the recruitment program has a contractual relationship with the ad network which includes the social media site. The same is true regarding social media visits by HC worker to Facility A or Facility B social media sites. All site upload the ii cookie into the HC device.

In step 246, the system populates the ad network with generic Hospital.com banner ads and sponsored link ads. The hyperlinks point to the TTP server ads or ads located onto the ad network servers. In step 248, the ad network detects the initial interest cookie on HC-W internet enabled device.

When the HC worker independently acts in step 249 and travels to anyone of the servers on the ad network, in step 248, the ad network detects the initial interest cookie on the internet enabled device. In step 250, the ad network generates and displays the banner ad or sponsored link ad which is uploaded to the website visited by the HC workers internet enabled device. In step 252, the system logs the second HC worker communication into the recruitment database. Continuing to FIG. 9B, in step 254, the system repeats the “detect touch” or comm event step 242 with the healthcare worker device and updates the healthcare worker cookie and logs the communication touch or comm event into the recruitment database. In decision step 256, a determination is made if the number of communication events exceed a predetermined number. If not, the system repeats step 254.

If YES, the system executes in step 258 a search for online data for the healthcare worker. This may include search through the social network, third party database etc. This third party data is entered into a recruitment tracker. In step 260, if a high quality healthcare worker is detected, the system in step 262 creates a semi custom landing page for this high quality worker. This high quality worker is determined by the four data point match described earlier. In step 264, the system directly targets the high quality HC worker by way of alternate communications channels. In step 266, the healthcare worker enters the system via the multiple channel program.

Returning to decision step 256, as an alternative to measuring the number of communications events, the decision step may involve a determination that the healthcare facility or healthcare provider needs a certain number of recruits. In other words, if the provider needs 25 nurses, the provider may seek out 100 nurses and execute step 258 if the recruitment computer can determine that the HC worker and internet enabled device is a nurse. This is a “recruitment needs” factor. By monitoring the subjects in the browser history of the HC device and third party database sources, a relative decision can be made that the healthcare worker and, more particularly the internet enabled device, is associated with the healthcare worker meeting those high qualifications.

In the drawings, and sometimes in the specification, reference is made to certain abbreviations. The following Abbreviations Table provides a correspondence between the abbreviations and the item or feature.

Abbreviations Table

| | |
|---|---|
| ad | advertisement |
| Admin | Administrator |
| A-com | computer or memory store for common or remainder data |
| addr | address - typically an IP address |
| alt. | alternate or optional path or step |
| API | application program interface |
| appln. | application, typically made by user or healthcare worker to a |
| | potential employer for either employment or work project |
| Appt-A | an HC-W (healthcare worker) who applies for a job, |
| | healthcare worker A |
| ASP | application service provider - server on a network |
| B-ext | computer or memory store for extracted data |
| bd | board |
| Bus. | Business |
| CD-RW | compact disk drive with read/write feature for CD disk |
| chrg | credit card charge slip |
| comm. | communications, typically telecommunications |
| comp | computer having internet enabled communications module |
| contrib. | contribution, as in charitable contribution |
| Cos. | companies |
| CPU | central processing unit |
| cr.cd. | credit card |
| DB | data base |
| disc | discount, as in discounting a credit card charge slip |
| Displ | display, typically display a web page or display certian |
| | information |
| doc | document |
| dry | drive, e.g., computer hard drive |
| Dr. | doctor |
| DS | data storage |
| e | encryption |
| e.g. | for example |
| em | email |
| equip | equipment |
| emp'ee | employee |
| emp'r | employer or potential employer |
| ext-data | extracted data |
| Fac | Facility, as in Healthcare Facility |
| Geo | geographic location or code (geo.loc. is GPS data) |
| GPS | geo positioning system and location (optionally time data) |
| HC-W | healthcare worker or a person who wishes to be a healthcare |
| | worker |
| HC field | a category or recognized field for healthcare workers, |
| | including doctors and Rns. |
| h-link | hyper link to a certain webpage or landing page |
| Hosp | hospital or any other type of healthcare employer such as a |
| | clinic, doctor's offer, nurse registry, temp agency for |
| | healthcare workers, etc. “Hospital.com” refers to a specific |
| | employer. Note: “Hosp” is not limited to hosptials but is |
| | generic for all healthcare service providers who seek |
| | employees and contracting service workers. |
| HR | human resources department or manager |
| h-link | hyper link to a web page |
| I/O | input/output |
| id | identify |
| ie or IE | Internet-enabled device, like asmart phone, tablet |
| | computer, computer, etc. |
| I-ext | Internet storage for extracted data |
| IP addr. | internet protocol address of internet enabled device |
| loc | location |
| loc. ptr. | displayed location on a displayed map |
| mem | memory |
| Mess | message as in SMS or text message |
| mkting | marketing |
| mbr | member |
| ntwk | network, namely a telecomm network, typically internet based |
| | network. A local area network is also possible. |
| obj | object, for example, a data object |
| opt | optional or alternative program or module |
| Pg. | page, typically a web page, may be a landing web page |
| pgm | program |
| ph | phone, namely an internet enabled phone, such as a smart |
| | phone |
| ph.no. | phone number |
| phy | physical as in physical therapist |
| Pro | provider, such as RX Pro, Medical Provider, namely, a doctor |
| pt. | point, as in jump point to another portion of the program |
| Pty | party engaged in telecomm or internet enabled |
| | communications |
| P/W | password |
| Rcd | database record or record profile |
| re | regarding or relating to |
| recon | reconstruct |
| Reg'd | registered as in Reg'd Pro, Registered Provider |
| rel | release |
| rem | reminder, such a a reminder email to the HC-W |
| RQT | request |
| rev | review |
| Rpt | Report |
| rt | real time, may include day and time stamp data |
| R Tkr | Recruit Tracker Program or DB |
| RX | medical drugs or medical equipment |
| sch | search |
| sec | security |
| sel | select |
| SL | security level (sometimes S1 for security level 1, etc.) |
| smart ph | smart phone coupled to the internet |
| SR | sales representative |
| sms | text message |
| stmt | statement, as in bank statement, or payment made statement |
| Svr | sever, as in web server |
| sys | system |
| Sys Op | System Operator |
| t | time |
| telecom | telecommunications system or network |
| tbl | tablet computer |
| TTP | Trusted Thrid Party system |
| UPP | user's personal profile, for example an HC worker completes |
| | a UPP prior to inputting data about his or her HC application. |
| URL | Uniform Resource Locator, x pointer, or other network |
| | locator |
| univ. | universal application or common application |
| w/ | with |
| w/in | within |
| w/out | without |
| wrt | with respect to |

### Description of Typical System Features

The system described above notes that the user has at least one, and sometimes multiple Internet-enabled (IE) devices, such as, smart phone, cell phone with an ap (an access point), tablet computer, computer, or other IE device that is internet enabled. Computer tablets and other electronic devices may be configured in this manner. The ap (an access point) or internet portal permits the person to access the system. If the user communicates with the system in a voice mode, the user interacts primarily with an interactive voice response system or module, an IVR.

The present invention relates processes data via computer systems, over the Internet and/or on a computer network (LAN or WAN), and computer programs, computer modules and information processing systems accomplish these tracking services.

It is important to know that the embodiments illustrated herein and described herein below are only examples of the many advantageous uses of the innovative teachings set forth herein. In general, statements made in the specification of the present application do not necessarily limit any of the various claimed inventions. Moreover, some statements may apply to some inventive features but not to others. In general, unless otherwise indicated, singular elements may be in the plural and vice versa with no loss of generality. In the drawings, like numerals refer to like parts or features throughout the several views.

The present invention could be produced in hardware or software, or in a combination of hardware and software, and these implementations would be known to one of ordinary skill in the art. The system, or method, according to the inventive principles as disclosed in connection with the preferred embodiment, may be produced in a single computer system having separate elements or means for performing the individual functions or steps described or claimed or one or more elements or means combining the performance of any of the functions or steps disclosed or claimed, or may be arranged in a distributed computer system, interconnected by any suitable means as would be known by one of ordinary skill in the art.

According to the inventive principles as disclosed in connection with the preferred embodiments, the invention and the inventive principles are not limited to any particular kind of computer system but may be used with any general purpose computer, as would be known to one of ordinary skill in the art, arranged to perform the functions described and the method steps described. The operations of such a computer, as described above, may be according to a computer program contained on a medium for use in the operation or control of the computer as would be known to one of ordinary skill in the art. The computer medium which may be used to hold or contain the computer program product, may be a fixture of the computer such as an embedded memory or may be on a transportable medium such as a disk, as would be known to one of ordinary skill in the art. Further, the program, or components or modules thereof, may be downloaded from the Internet of otherwise through a computer network.

The invention is not limited to any particular computer program or logic or language, or instruction but maybe practiced with any such suitable program, logic or language, or instructions as would be known to one of ordinary skill in the art. Without limiting the principles of the disclosed invention any such computing system can include, inter alia, at least a computer readable medium allowing a computer to read data, instructions, messages or message packets, and other computer readable information from the computer readable medium. The computer readable medium may include non-volatile memory, such as ROM, flash memory, floppy disk, disk drive memory, CD-ROM, and other permanent storage. Additionally, a computer readable medium may include, for example, volatile storage such as RAM, buffers, cache memory, and network circuits.

Furthermore, the computer readable medium may include computer readable information in a transitory state medium such as a network link and/or a network interface, including a wired network or a wireless network, that allow a computer to read such computer readable information.

### Basic Concepts for Ad Network

An online advertising network or ad network is a company or a group of companies that connect advertisers to web sites that want to host advertisement. The key function of an ad network is aggregation of ad space supply from website publishers and matching the ad space available on a group of websites with advertiser demand. The phrase “ad network” as used herein refers to an online ad network as the effect of aggregation of publisher ad space and sale of that space to advertisers is most commonly seen in the online space. The fundamental difference between traditional media ad networks and online ad networks is that online ad networks use a central Ad server to deliver advertisement to consumers which enables targeting, tracking and reporting of impressions in ways not possible with analog media alternatives. Ad networks are primarily involved in selling space for online ads to appear. This online advertising inventory comes in many different forms, including space on websites, in RSS feeds, on blogs, in instant messaging applications, in adware, in e-mails, and on other sources. The dominant form of inventory continues to be third party websites, who work with advertising networks for either a fee or a share of the ad revenues.

An advertiser can buy a run of network package, or a run of category package within the network. The advertising network serves advertisements from its central ad server, which responds to a site once a page is called. A snippet of code is called from the ad server, that represents the advertising banner. There are three main types of ad networks: vertical networks, blind networks and targeted networks. In general, the Recruitment System and Method described herein operates within targeted networks. Specific targeting technologies such as behavioral or contextual, that have been built into an Ad server. Targeted networks specialize in using consumer clickstream data to enhance the value of the inventory they purchase. Further specialized targeted networks include social graph technologies which attempt to enhance the value of inventory using connections in social networks.

The claims appended hereto are meant to cover modifications and changes within the scope and spirit of the present invention.

What is claimed is:

1. A computer-based method for recruiting a healthcare professional who uses an internet-enabled device to communicate with a recruitment computer server system via a telecommunications network, said recruitment computer server coupled to a recruitment database, the method comprising:
uploading a cookie onto the healthcare professional's internet-enabled device whenever the interne-enabled device engages in a telecommunications event with the recruitment computer server system, said cookie upload delivered by said recruitment computer server;
said recruitment computer server gathering a browser history from said professional's internet-enabled device whenever the internet-enabled device engages in a telecommunications event with the recruitment computer server system and logging said browser history unique to said healthcare professional into said recruitment database, said browser history associated with a unique healthcare professional identifier in said recruitment database;
creating a custom internet ad unique to either said healthcare professional or unique to a professional field for said healthcare professional or unique to a geographic location for said healthcare professional;
creating a healthcare professional webpage for said healthcare professional, when: (a) the number of telecommunications events with the recruitment computer server system by the internet-enabled device of the healthcare professional exceeds a predetermined number; (b) a projected annual salary for a class of healthcare professionals exceeds a predetermined value and said healthcare professional is within said class; or (c) an employer has recruitment needs for a number of healthcare professional recruits;
inserting a hyperlink into said custom internet ad, said hyperlink pointing to said healthcare professional webpage;
delivering and effecting the display of said custom internet ad to said internet-enabled device based upon detection of said cookie;
delivering and effecting the display of said healthcare professional webpage to said internet-enabled device due to an activation of said hyperlink; and
accepting employment related data or personal profile data from said healthcare professional via said recruitment computer server and associating the earlier logged data with said personal profile data.

2. A computer-based method for recruiting the healthcare professional as claimed in claim 1 wherein the recruitment computer server is coupled via the telecommunications network to an ad network deployed over the telecommunications network, and
wherein the step of gathering said browser history for said recruitment computer server and said recruitment database includes gathering said browser history via said ad network when said internet-enabled device engages in a telecommunications event with the ad network; and
transferring the browser history from the ad network to said recruitment computer server.

3. A computer-based method for recruiting the healthcare professional as claimed in claim 1 wherein said unique healthcare professional identifier is unique to the healthcare professional's internet-enabled device.

4. A computer-based method for recruiting the healthcare professional as claimed in claim 1 wherein said cookie is uploaded onto said healthcare professional's internet-enabled device the first time such device has a telecommunications event with the recruitment computer server system.

5. A computer-based method for recruiting the healthcare professional as claimed in claim 1 including creating a generic webpage to be served up by said recruitment computer server to a visitor's internet-enabled device and wherein said cookie is uploaded onto said visitor's internet-enabled device during such telecommunications event with the recruitment computer server system.

6. A computer-based method for recruiting the healthcare professional as claimed in claim 1 wherein the creation of said healthcare professional webpage further occurs when said employer has recruitment needs which exceeds a predetermined number of healthcare professional recruits.

7. A computer-based method for recruiting the healthcare professional as claimed in claim 1 wherein the recruitment computer server is coupled via the telecommunications network to an ad network deployed over the telecommunications network, and
wherein the step of delivering and effecting the display of said custom internet ad to said internet-enabled device based upon detection of said cookie by said ad network.

8. A computer-based method for recruiting the healthcare professional as claimed in claim 1 wherein the recruitment database is a spread sheet.

9. A computer-based method for recruiting the healthcare professional as claimed in claim 2 wherein the step of delivering and effecting the display of said custom internet ad to said internet-enabled device based upon detection of said cookie by said ad network.

10. A computer-based method for recruiting the healthcare professional as claimed in claim 9 including tracking said internet-enabled device with said cookie via said ad network and logging browser histories and tracking data into said recruitment database.

11. A computer-based method for recruiting the healthcare professional as claimed in claim 1 including:
populating said recruitment database with healthcare professional data from one or more third party sources of healthcare professional data; and
wherein logging said browser history unique to the interne-enabled device for said healthcare professional includes matching the third-party supplied data with either said browser history or said healthcare professional internet-enabled device.

12. A computer-based method for recruiting the healthcare professional as claimed in claim 11 wherein the creation of said healthcare professional webpage includes creating said healthcare professional webpage which is unique to said healthcare professional.

13. A computer-based method for recruiting the healthcare professional as claimed in claim 1 wherein the custom interne ad is either a banner ad or a sponsored link ad.

14. A computer-based method for recruiting a healthcare professional who uses an internet-enabled device to communicate with a recruitment computer server system via a telecommunications network, said recruitment computer server coupled to a recruitment database, and an ad network deployed over the telecommunications network and coupled to said recruitment computer server, the method comprising:
initially uploading a cookie onto the healthcare professional's interne-enabled device when the internet-enabled device engages in a telecommunications event with the recruitment computer server system, said cookie upload delivered by said recruitment computer server;
said recruitment computer server gathering a browser history from said professional's internet-enabled device either directly or through said ad network whenever the interne-enabled device engages in a telecommunications event with either the recruitment computer server system or said ad network;
logging said browser history unique to said healthcare professional into said recruitment database, said browser history associated with either a unique healthcare professional identifier or an internet-enabled device identifier in said recruitment database;
creating a custom internet ad unique to either said healthcare professional or unique to a professional field for said healthcare professional or unique to a geographic location for said healthcare professional;
creating a healthcare professional webpage, unique to either said healthcare professional or unique to a professional field for said healthcare professional or a geographic location unique to said healthcare professional;
inserting a hyperlink into said custom internet ad, said hyperlink pointing to said healthcare professional webpage;
delivering and effecting the display of said custom internet ad to said internet-enabled device based upon detection of said cookie when said internet-enabled device engages in a telecommunications event with said ad network; and
delivering and effecting the display of said healthcare professional webpage due to an activation of said hyperlink;
accepting further healthcare professional data from said healthcare professional via the healthcare professional webpage on said recruitment computer server and associating the earlier logged data with said further healthcare professional data.

15. A computer-based method for recruiting the healthcare professional as claimed in claim 14 wherein the step of gathering said browser history for said recruitment computer server and said recruitment database includes gathering said browser history via said ad network when said internet-enabled device engages in a telecommunications event with the ad network; and
transferring the browser history from the ad network to said recruitment computer server.

16. A computer-based method for recruiting the healthcare professional as claimed in claim 14 including creating a generic webpage to be served up by said recruitment computer server to a visitor's interne-enabled device and wherein said cookie is uploaded onto said visitor's internet-enabled device during such telecommunications event with the recruitment computer server system.

17. A computer-based method for recruiting the healthcare professional as claimed in claim 14 including tracking said internet-enabled device with said cookie via said ad network and logging browser histories and tracking data into said recruitment database.

18. A computer-based method for recruiting the healthcare professional as claimed in claim 14 including:
populating said recruitment database with healthcare professional data from one or more third party sources of healthcare professional data; and
wherein logging said browser history unique to the interne-enabled device for said healthcare professional includes matching the third-party supplied data with either said browser history or said healthcare professional internet-enabled device.

19. A computer-based method for recruiting the healthcare professional as claimed in claim 14 wherein the custom interne ad is either a banner ad or a sponsored link ad.

20. A computer system for recruiting a healthcare professional who uses an internet-enabled device to communicate with a recruitment computer server system via a telecommunications network, said recruitment computer server coupled to a recruitment database, and an ad network deployed over the telecommunications network and coupled to said recruitment computer server, the healthcare professional's internet-enabled device adapted to communicate over said telecommunications network to one or the other of said recruitment computer server or said ad network, the system comprising:
a computer having a processor and a memory which supports the operation of said recruitment computer server, said computer having a data portal and a web server portal communicatively coupled to said telecommunications network, said memory containing said recruitment database;
as part of said computer, processor and memory, means for uploading a cookie onto the healthcare professional's internet-enabled device when the interne-enabled device engages in a telecommunications event with the computer via the web server portal;
means for accepting, as part of said computer via said data portal, a browser history from said professional's internet-enabled device either directly or through said ad network whenever the internet-enabled device engages in a telecommunications event with either the recruitment computer server system or said ad network;
means for storing said browser history unique to said interne-enabled device for the healthcare professional into said recruitment database, said browser history associated with either a unique healthcare professional identifier or an internet-enabled device identifier in said recruitment database;
an ad generator, operative with said processor, said memory and said database, for creating a custom internet ad unique to either said healthcare professional or unique to a professional field for said healthcare professional or unique to a geographic for said healthcare professional;
a webpage publisher, operative with said processor, said memory and said database, for creating a healthcare professional webpage, unique to either said healthcare professional or unique to a professional field for said healthcare professional or a geographic location unique to said healthcare professional, said recruitment computer server causing said webpage publisher to effect the display of said healthcare professional webpage upon activation of an associated hyperlink;
means for inserting said associated hyperlink into said custom internet ad, said hyperlink pointing to said healthcare professional webpage;
at said web server portal, means for accepting further healthcare professional data from said healthcare professional via the healthcare professional webpage on said recruitment computer server;
said means for storing further storing said further healthcare professional data in said recruitment database; and
means for associating said browser history and at least one of said unique healthcare professional identifier or said internet-enabled device identifier with said further healthcare professional data in said recruitment database.
